(19) United States
(12) Patent Application Publication
(10) Pub. No.: US 2018/0297720 A1
(43) Pub. Date: Oct. 18, 2018

(54) HINGE

(71) Applicant: OXFORD SPACE SYSTEMS LIMITED, Didcot (GB)

(72) Inventors: Vincent Fraux, Didcot (GB); Juan Reveles-Wilson, Abingdon (GB)

(21) Appl. No.: 15/776,329

(22) PCT Filed: Oct. 28, 2016
(86) PCT No.: PCT/GB2016/053357

§ 371 Date: May 15, 2018

(30) Foreign Application Priority Data
Nov. 16, 2015 (GB) 1520187.4

(51) Int. Cl. B64G 1/22; E05D 3/12; F16C 11/12; E05F 1/12; F16C 11/10

(52) U.S. Cl. CPC B64G 1/222; E05D 3/122; F16C 11/12; B64G 1/407; F16C 11/10; E05Y 2900/502; E05F 1/1284

(57) ABSTRACT

A hinge (1) attaches between two elements (4) in a deployable structure. The hinge (1) includes support members (2) for attaching to or forming part of the elements (4). The hinge (1) also includes two gears (8) in mesh with each other, each gear (8) attached to a support member (2), with the gears (8) rotating about parallel axes. The hinge also includes a tape spring (16) attached to and extending between the support members (2). The tape spring (16), when extended longitudinally, lies substantially in a plane parallel to the axes of the gears. The tape spring (16) is arranged to actuate the hinge from a folded configuration towards an extended configuration. The hinge (1) also includes a retaining member (18) attached to the gears (8) and/or the support members (2). The retaining member (18) is arranged to restrict the separation of the gears (8) in a direction extending between the axes of the gears.

### STATEMENT OF RELATED APPLICATIONS

This application is a 35 U.S.C. § 371 national phase filing of International Application No. PCT/GB2016/053357 filed on Oct. 28, 2016, which claims priority to United Kingdom Patent Application No. 1520187.4 filed on Nov. 16, 2015, with the contents of the foregoing applications hereby being incorporated by reference herein in their respective entireties.

### TECHNICAL FIELD

This invention relates to a hinge, in particular to a geared hinge actuated by a tape spring.

### BACKGROUND

Deployable structures such as antennas, solar panels, solar sails, etc., are constructed from a number of interlinked elements which are arranged to move in a coordinated fashion in order to deploy the structure. This enables such deployable structures to be used as part of larger structures which are launched into space, e.g. satellites or other, e.g. manned, spacecraft, because the deployable structures are folded when launched and subsequently deployed.

The interlinked elements of a deployable structure may be joined at a hinge that is actuated in order to deploy the structure, i.e. to rotate two elements of the structure joined at the hinge relative to each other about the axis of the hinge. A tape spring can provide a simple, reliable and low mass actuation mechanism for such hinges.

### SUMMARY

The aim of the present invention is to provide an improved hinge that incorporates a tape spring.

When viewed from a first aspect the invention provides a hinge for attachment between two elements in a deployable structure, the hinge comprising:
two support members each for attaching to or forming part of an element of the deployable structure;
two gears in mesh with each other, each gear being attached to a respective one of the support members, and the gears being arranged for rotation about parallel axes relative to each other;
a tape spring attached to and extending between the support members, the tape spring when extended longitudinally in a direction perpendicular to the axes of the gears lying substantially in a plane parallel to the axes of the gears, and the tape spring arranged to actuate the hinge from a folded configuration in which the tape spring is bent along a direction parallel to the axes of the gears towards an extended configuration in which the tape spring is extended longitudinally; and
a retaining member attached to one or both of the gears and the support members, the retaining member being arranged to restrict the separation of the gears in a direction extending between the axes of the gears.

The present invention therefore provides a hinge that is able to connect two elements in a deployable structure, via two gears and two support members, to enable these interlinked elements to rotate relative to each other. The gears, which are meshed together, allow the rotation of the two support members relative to each other, with the gears each rotating relative to each other about respective parallel axes (and thus the gears substantially rotate in a plane or parallel planes perpendicular to the axes of the gears).

The movement of the hinge is actuated by a tape spring that is connected between the two support members. When the tape spring is extended (i.e. straight) it lies substantially in a plane parallel to the axes of the gears. (The tape spring does not lie completely in this plane owing to its curved cross section in this configuration, however the tangent to the centre center of the tape spring is parallel to this plane.)

In a folded configuration of the hinge the tape spring is bent, e.g. at a longitudinal midpoint of the tape spring, along a direction parallel to the axes of the gears. In this configuration the tape spring possesses an amount of stored strain energy which, when released, acts to unfurl the tape spring towards its longitudinally extended configuration. This unfurling of the tape spring acts to rotate the gears of the hinge, via their connection to the support members to which the tape spring is attached, and thus actuate the hinge from its folded configuration towards its extended configuration. Therefore, when the support members are connected to, or forming part of, respective elements of a deployable structure, the actuation of the hinge rotates these interlinked elements relative to each other to help deploy the deployable structure.

The hinge also includes a retaining member that is attached to the gears and/or to the support members. The retaining member acts to restrict the separation of the gears (and thus the hinge) in a direction extending between (and thus perpendicular to) the axes of the gears.

Thus it will be appreciated that the hinge has a design that can accommodate a tape spring and which is self-actuating owing to the tape spring being connected between the support members. Tape springs are simple, reliable, have relatively low mass compared to other actuation devices, e.g. which may comprise motors and wiring, and thus tape springs are convenient for use in deployable structures, particularly in space. Tape springs also offer a torque profile that has a low torque during most of their deployment, which helps to provide a low speed, smooth deployment, and a higher torque at the end of their deployment, which helps to lock the tape spring into its fully extended configuration, if this is desired. This is different from, and advantageous over, other types of stored energy devices, e.g. helical springs. Furthermore, the manner in which tape springs fold is not compatible with conventional hinges, e.g. that include a pin along the axis of rotation.

The hinge also includes a retaining member that limits the separation of the gears (in a direction extending between the axes of the two gears), i.e. the retaining member is arranged to maintain a constant distance between the axes of the two gears and thus keeps the two gears in mesh. This restriction of the gears' movement increases the stiffness of the hinge (particularly the longitudinal stiffness of the hinge) and thus helps to provide a rigid hinge that can withstand large forces.

The increased stiffness of the hinge increases the accuracy and predictability of its actuation by the tape spring into its extended configuration as well as an increased stiffness when fully deployed. This is particularly important for deployable structures operating in a low gravity environment (e.g. space) and contrasts with conventional hinges including tape springs, whose movement during deployment may be unpredictable and involve some out of plane motion, as well as having a low stiffness when fully deployed.

The use of gears in the hinge also helps to reduce the two sides of the hinge slipping against each during deployment, e.g. compared to using wheels, owing to the friction of the gear teeth meshing with each other, thus aiding in the accuracy and predictability of the hinge's deployment.

The two support members may be any suitable and desired shape for attaching to, or forming part of, an element of the deployable structure and for attaching to one of the gears. For attaching to an element of the deployable structure (which may comprise one of many different types of components) the shape of the support members are preferably designed for the specific type of components to which they are to be attached and therefore many different designs for the support member are envisaged to allow for attachment to the respective elements of the deployable structure. Alternatively the support members form an, e.g. integral, part of the element of the deployable structure. This may help to increase the stiffness of the deployable structure.

For attaching to the gears the support members are preferably attached to the opposite side of the gears to the meshing gear teeth. As discussed below, preferably the gear teeth do not extend around the side of the gears to which the respective support members are attached.

In one embodiment each of the support members is longitudinally extended, e.g. a strut, having one end for attaching to, or forming part of, a respective element of the deployable structure and an opposite end for attaching to a respective one of the gears.

The support members may be made separately from the gears and affixed thereto in any suitable and desired manner. However in one embodiment each support member and corresponding gear is integrally formed (e.g. formed from the same, single piece of material), e.g. made from plastic that has been, for example, moulded or 3D printed. This helps to increase the stiffness of the hinge.

The support members may be made from any suitable and desired material, e.g. depending on the size or application of the hinge. Preferably the support member comprises one or more of a metal (e.g. aluminium, (stainless) steel, bronze or titanium), a (thermo)plastic and a composite (e.g. a fibre reinforced plastic), e.g. that is moulded, 3D printed or machined.

The two gears may comprise any suitable and desired type of gears. In one embodiment the two gears comprise spur gears. The teeth of spur gears (extending in a direction parallel to the axes of the gears) help to increase the shear stiffness of the hinge. In another embodiment the two gears comprise helical gears. Helical gears have been found to reduce the backlash of the gears and increase the stiffness of the hinge, e.g. compared to spur gears, with the increased stiffness being in multiple directions owing to the gear teeth extending at an angle to the axes of the gears.

The gear teeth may not extend round the full circumference of the gears owing to the hinge generally having a limited angle through which it rotates, e.g. 180 degrees or less (though hinges having a greater angle of rotation are also contemplated). Preferably the gear teeth on each gear are provided around an arc of the circumference, e.g. on the side of each gear opposite to where the respective support member attaches, wherein the arc subtends an angle of between 80 and 140 degrees, e.g. between 90 and 130 degrees, e.g. between 100 degrees and 120 degrees, e.g. approximately 110 degrees.

Providing teeth around only an arc of the circumference also helps to attach the gears to the respective support members, as this connection may be provided conveniently on the opposite side of the gears to the gear teeth, as discussed above.

As has been discussed above, the friction of the meshing gear teeth (acting against the spring force of the tape spring) damps the deployment of the hinge (which may be exploited advantageously in some embodiments). Therefore in one embodiment the gears each comprise a gear support and a set of gear teeth arranged around at least part of the circumference of the gear support, wherein the gear teeth and the gear support are formed from separate parts and attached together to form the gear. This enables the material used for the gear teeth to be chosen for its, e.g. frictional, properties and the material used for the gear support to be chosen for its structural (e.g. stiffness) properties. Preferably the gear teeth comprise a thermoplastic, e.g. polyether ether ketone (PEEK) or acetal resin (e.g. Delrin® (E. I. Du Pont de Nemours and Co., Wilmington, Del.). Preferably the gear is attached to the respective support member via the gear support.

In another embodiment the gears (e.g. the gear teeth and the gear support) are integrally formed, e.g. from a single material. This may help to increase the stiffness of the gears and may give a simpler manufacturing process.

The gears may be made from any suitable and desired material. In one embodiment the gears comprise one or more of a metal (e.g. aluminium, (stainless) steel, bronze or titanium), a (thermo)plastic and a composite (e.g. a fibre reinforced plastic), e.g. that is moulded, 3D printed or machined.

Preferably the gears (when rotating relative to each other) maintain a constant centre center distance, i.e. a constant distance between the axes about which the gears rotate respectively. Thus preferably the gears are circular (or form at least an arc of a circle). Preferably the two gears are the same size (i.e. radius of curvature) as each other and thus have a gear ratio of 1.

The depth of the gears (i.e. the dimension in a direction parallel to the axes of the gears) may be any suitable and desired dimension, e.g. compared to the dimension in a direction perpendicular to the axes of the gears (e.g. the radius of the gears). In one embodiment the gears are disc-shaped (or form at least a segment of a disc), e.g. such that the depth of the gears is less than the radius of the gears. This disc (or planar) shape helps to reduce the mass of the hinge while maintaining its stiffness.

The two gears may be arranged in the hinge in any suitable and desired way. Preferably the plane in which the gears rotate is offset from the lateral edge of the tape spring closest to the gears. This provides clearance of the gears from the tape spring, both when the tape spring is folded and extended.

The hinge may comprise only two gears but in one embodiment the hinge comprises two sets of two gears, e.g. in mesh with each other, each gear being attached to a respective one of the support members, and the gears in each set being arranged for rotation about parallel axes relative to each other. As will be appreciated this helps to increase the stiffness of the hinge further. Preferably the respective planes in which the two sets of gears rotate are parallel to, but offset from, each other (and preferably also the tape spring, as described above). Thus preferably the two sets of gears are arranged either side of the tape spring, i.e. with the tape spring between the two sets of gears. Preferably the two axes of one of the set of gears are coaxial with the two axes of the other set of gears.

In the embodiment comprising two sets of gears preferably the hinge comprises two retaining members, each retaining member being attached to one or both of the sets of gears and/or the support members, each retaining member being arranged to restrict the separation of the respective gears in a direction extending between the axes of the respective gears. The hinge preferably also comprises two sets of two support members each for attaching to, or forming part of, an element of the deployable structure. In this embodiment one support member from each set (i.e. on the same side of the hinge) could attach separately to the respective element of the deployable structure but preferably the support members on each side of the hinge attach to, or form part of, the respective elements of the deployable structure via a common mounting member. Preferably the mounting member and the respective support members (i.e. on the same side of the hinge) are integrally formed.

In the embodiments comprising two sets of gears, each set of gears may comprise one or more of the above described optional features (which may be different for each set of gears). However, preferably the two sets of gears are substantially identical, e.g. other than preferably being mirror images of each other.

Tape springs are generally straight, thin, elastic strips of material with a curved cross section (in a plane perpendicular to the direction of longitudinal extension of the tape spring). The curved cross section in the extended configuration of the tape spring has the effect that when the tape spring is bent or folded laterally in a direction perpendicular to the direction of longitudinal extension of the tape spring, a local elastically deformed region having zero transverse curvature is formed that possesses stored strain energy. This stored strain energy is released during deployment to deploy the tape spring (and thus the hinge) towards its extended configuration.

In one embodiment the hinge is arranged such that, in the extended configuration of the hinge, the tape spring is allowed to extend into its fully longitudinally extended configuration. This may be achieved in any suitable and desired way, e.g. as discussed below through the provision of a stop or lack thereof such that the hinge is able to open far enough to allow the tape spring to extend fully. In this fully extended (straight) configuration, preferably the tape spring is arranged to lock, i.e. such that it cannot be folded without the tape spring being acted on directly.

The tape spring could be any type of tape spring and thus could comprise any suitable and desired material, e.g. chosen depending on the desired stiffness, mass and torque properties for the tape spring. For example the tape spring could be made of metal, e.g. Beryllium Copper. In another embodiment the tape spring could be made of a composite, e.g. a fibre-reinforced polymer, e.g. a carbon-fibre reinforced polymer.

The hinge may comprise only a single tape spring however preferably the hinge comprises two or more tape springs, each tape spring being attached to and extending between the support members, the tape springs when extended longitudinally in a direction perpendicular to the axes of the gears lying substantially in a plane parallel to the axes of the gears, and the tape springs arranged to actuate the hinge from a folded configuration in which the tape springs are bent along a direction parallel to the axes of the gears towards an extended configuration in which the tape springs are extended longitudinally. Providing two tape springs increases the torque available for deployment of the hinge and improves the stiffness and locking of the hinge (in the embodiments that are arranged to lock).

(Embodiments are also envisaged in which the hinge comprises a plurality of tape springs (e.g. many more than two, such as up to twenty), e.g. arranged in pairs. Such embodiments may be for a laterally extended hinge, e.g. for attachment to a (solar) panel, which may have a width of up to, e.g., 3 m, where the tape springs are arranged in parallel and thus generate a large torque.)

The two tape springs may be arranged in the hinge in any suitable and desired manner. Preferably the tape springs are arranged to be parallel to each other (i.e. such that the planes in which they lie substantially are parallel) and spaced from each other in a direction perpendicular to the planes in which they lie substantially. The tape springs may be arranged such that their curvatures are in the same direction, i.e. their concave sides are facing the same direction, but preferably the tape springs are arranged such that their curvatures are in opposite directions, preferably such that the concave sides are facing each other. This latter arrangement, in particular, has been found to increase the stiffness and the locking of the hinge (in the embodiments that are arranged to lock).

In the embodiments in which the hinge comprises two tape springs, the two tape springs could be made separately and each attached to the support members. However in one embodiment (e.g. in which the tape springs are arranged in the hinge such that their concave sides are facing each other) the tape springs are attached to each other at one, or preferably both, ends. This has been found to be particularly convenient when the tape springs are made from a composite material.

In the embodiment in which the tape springs are attached to each other, preferably the two tape springs are integrally formed. The manner in which the tape springs are attached to other at each ends may be in any suitable and desired way. In one embodiment (e.g. in which the tape springs are integrally formed) the tape springs comprise a cylindrical end (at one or both ends) from which each tape spring extends. Preferably the curvature of each tape spring (when extended) is equal to the curvature of the cylindrical end (e.g. the tape springs are formed from a cylinder with a longitudinally extended slit on opposite sides of the cylinder). This helps to provide a convenient spacing between the tape springs for use in the hinge and a cylinder (e.g. at each end) that can be conveniently used to mount the tape spring(s) onto the support member(s).

Preferably the hinge comprises a release mechanism for holding the hinge (and tape spring) in its folded configuration (i.e. before deployment to counter the force exerted by the bent tape spring) and arranged to release the hinge such that the tape spring actuates the hinge towards its extended configuration. Alternatively the release mechanism may not form part of the hinge but instead is attached to the elements of the deployable structure. The release mechanism may comprise any suitable and desired mechanism to perform this function, e.g. a latch, clasp or clamp.

The retaining member may comprise any suitable and desired design for attachment to one or both of the gears and the support members and for restricting the separation of the gears in a direction extending between the axes of the gears, and may attach to one or both of the gears and the support members in any suitable and desired way.

In a preferred embodiment the retaining member is arranged to restrict the movement of the gears in directions out of a plane perpendicular to the axes of the gears, i.e. in any direction (e.g. axially) other than the planar rotation of the gears in which the gears are (e.g. preferably) able to move freely.

This restriction of the gears' movement (and thus that of the hinge) to substantially one degree of freedom (the rotation of each of the gears about their respective axes substantially in a plane (or parallel planes) perpendicular to the axes of the gears) by the retaining member, but also in part by the meshing of the gears (owing to the gear teeth reducing the out of plane movement of the gears), increases the out of plane stiffness of the hinge (e.g. the shear and torsional stiffness of the hinge) and thus helps to provide a rigid hinge that can withstand large out of plane forces. This is in addition to the increased stiffness the retaining member provides by restricting the separation of the gears.

The increased stiffness of the hinge increases the accuracy and predictability of its actuation by the tape spring into its extended configuration as well as an increased out of plane stiffness when fully deployed. This is particularly important for deployable structures operating in a low gravity environment (e.g. space) and contrasts with conventional hinges including tape springs, whose movement during deployment may be unpredictable and involve some out of plane motion, as well as having a low stiffness when fully deployed.

Preferably the retaining member is arranged to restrict the movement of the gears in directions out of a plane perpendicular to the axes of the gears by less than 1 degree (e.g. in any direction out of the plane perpendicular to the axes of the gears).

Preferably the retaining member is attached to and extends between an axle of each of the two gears. In this arrangement the gears are able to rotate about their respective axles (which extend coaxially along the directions of the respective axes of the gears) and the retaining member restricts the out of plane movement of the gears by restricting the off-axis movement of the gears' axles. This arrangement also helps to maintain a constant distance between the axes of the two gears. The gears may rotate about their respective axes in any suitable and desired way, e.g. via a plain bearing (suitable for a smaller hinge) or a rolling element (e.g. ball) bearing (suitable for a larger hinge). In the embodiment in which the gears each comprise an axle that rotates in a bearing, the bearing may be formed in the gears or in the retaining member.

In one embodiment the retaining member comprises a plate, e.g. lying substantially in a plane parallel and adjacent to the plane in which the gears rotate. A planar retaining member helps to cover the gears, e.g. to prevent things (such as cables) becoming entangled in the gears, and to prevent the ingress of dirt, etc. A planar retaining member also enables additional structural features to be attached or formed on the retaining member, as will be described below.

In another embodiment the retaining member comprises a strut, e.g. attached to and extending between the respective axles of the gears.

Preferably the retaining member lies on the opposite side of the gears from the tape spring, e.g. on the outside of the hinge, though this is not essential and other arrangements are contemplated. Thus, in the embodiment in which the hinge comprises two sets of gears and two retaining members, and the two sets of gears are arranged either side of the tape spring(s), preferably the two retaining members are arranged on the outside of the hinge (on opposite sides).

In the embodiment comprising two sets of gears and two retaining members, as described above, preferably the hinge comprises a bracing member that extends between the two retaining members, the bracing member arranged to restrict movement of the two sets of gears relative to each other, e.g. in a direction parallel to the axes of the gears. The bracing member thus acts to maintain the distance between the two retaining members and preferably also the two sets of gears, thus helping to increase the out of plane stiffness of the hinge.

The bracing member may be formed and attached to the retaining members in any suitable and desired way (e.g. to be clear of the tape springs). For example, the bracing member may be a separate part which fits between the two retaining members, the bracing member may be integrally formed with the two retaining members or at least part of the bracing member may be integrally formed with one or both of the retaining members.

The retaining member may be made from any suitable and desired material, e.g. the same material as the gears and/or the support members. In one embodiment the retaining member comprises one or more of a metal (e.g. aluminium, (stainless) steel, bronze or titanium), a (thermo)plastic and a composite (e.g. a fibre reinforced plastic), e.g. that is moulded, 3D printed or machined.

The hinge (and the components thereof) may be any suitable and desired size, e.g. as is necessary for the requirements of the elements of the deployable structure that the hinge is connecting and deploying. In one embodiment the tape spring, when extended longitudinally, is between 0.01 m and 2 m long, e.g. between 0.05 m and 1 m long, e.g. between 0.1 m and 0.5 m long, e.g. between 0.25 m long and 0.4 m long.

In a set of embodiments the hinge comprises a stop arranged to prevent the hinge from opening greater than a predetermined opening angle (the angle between the two ends of the tape spring as the hinge deploys). Providing a stop helps to control the end point of travel of the hinge when it is deployed, e.g. so that it does not overshoot its intended opening angle. This further helps with the accurate deployment of the elements of the deployable structure.

The opening stop may be provided on the hinge in any suitable and desired way, e.g. forming part or attached to any suitable and desired component of the hinge. In one embodiment the retaining member comprises the stop. This is particularly convenient in the embodiment in which the retaining member comprises a plate. In this embodiment preferably the stop comprises a projecting member that projects from the retaining member in a direction parallel with the axes of the gears, wherein the projecting member is arranged to engage with the respective gear and/or support member to prevent the hinge from opening greater than a predetermined opening angle. Preferably the stop comprises two projecting members that project from the retaining member in a direction parallel with the axes of the gears, wherein the projecting members are arranged to engage with the respective gears and/or support members to prevent the hinge from opening greater than a predetermined opening angle.

In another embodiment one or more of the gears comprise the opening stop. In this embodiment preferably the stop comprises a projecting member that projects from one or more of the gears in a direction perpendicular to the axes of the gears, wherein the projecting member is arranged to engage with the other of the two gears or a projecting member projecting therefrom to prevent the hinge from opening greater than a predetermined opening angle. Preferably the each of the two gears (that mesh together) has an opening stop comprising a projecting member, with these projecting members abutting each other at the predetermined opening angle.

The predetermined opening angle may be any suitable and desired angle, e.g. depending on the design and intended use of the hinge. In a preferred embodiment the predetermined opening angle is less than or equal to 180 degrees, e.g. approximately 180 degrees. This prevents the hinge opening out greater than the angle to which the hinge is desired to be deployed. In the embodiment in which the tape spring is prevented from locking, preferably the stop is arranged such that the predetermined opening angle is less than 180 degrees, e.g. such that the opening stop prevents the tape spring from locking. In the embodiment in which the tape spring locks, preferably the stop is arranged to allow the tape spring to lock but to prevent the hinge from opening substantially any further than the opening angle at which the tape locks. Typically this opening angle (at which the tape spring locks) will be approximately 180 degrees. (It should be noted that although the tape spring will generally be arranged to lock at an opening angle of approximately 180 degrees, the support members (and thus the rest of the two sides of the hinge) may form a different angle to each other in this configuration.)

Additionally or alternatively, in a set of embodiments the hinge comprises a stop arranged to prevent the hinge from being held together at less than a predetermined closing angle (the angle between the two ends of the tape spring before the hinge deploys). Providing a stop helps to control the minimum angle at which the hinge is held before it is deployed, e.g. by a release mechanism. Preferably the predetermined closing angle is less than 5 degrees.

The closing stop may be provided on the hinge in any suitable and desired way, e.g. forming part or attached to any suitable and desired component of the hinge. In one embodiment the retaining member comprises the stop. This is particularly convenient in the embodiment in which the retaining member comprises a plate. In this embodiment preferably the stop comprises a projecting member that projects from the retaining member in a direction parallel with the axes of the gears, wherein the projecting member is arranged to engage with the respective gear and/or support member to prevent the hinge from opening greater than a predetermined opening angle. In the embodiment in which the hinge comprises two sets of gears and two retaining members, with a bracing member extending between the two retaining members, as described above, preferably the bracing member comprises the stop.

In another embodiment one or more of the gears comprise the closing stop. In this embodiment preferably the stop comprises a projecting member that projects from one or more of the gears in a direction perpendicular to the axes of the gears, wherein the projecting member is arranged to engage with the other of the two gears or a projecting member projecting therefrom to prevent the hinge from being held together at less than a predetermined closing angle. Preferably the each of the two gears (that mesh together) has a closing stop comprising a projecting member, with these projecting members abutting each other at the predetermined opening angle.

In a further embodiment one or more of the support members comprise the closing stop. In this embodiment preferably the stop comprises a projecting member that projects from one or more of the support members in a direction perpendicular to the axes of the gears, wherein the projecting member is arranged to engage with the other of the two support members or a projecting member projecting therefrom to prevent the hinge from being held together at less than a predetermined closing angle. Preferably the each of the two support members has a closing stop comprising a projecting member, with these projecting members abutting each other at the predetermined opening angle.

In one embodiment the stop comprises a damping mechanism arranged to damp the movement of the hinge when the stop acts, e.g. engages with the respective gear and/or support member. This is particularly convenient in the embodiment in which the stop is provided to prevent the hinge from opening greater than a predetermined opening angle as the damping mechanism helps to reduce any shocks that may be produced when the hinge reaches the maximum opening angle and the stop engages, thus minimising the propagation of any shockwaves through the hinge and the associated elements of the deployable structure.

In one embodiment the stop (one or both of the closing and opening stops, but preferably the opening stop) comprises an electrical terminal, wherein an electrical connection is made when the stop engages. This allows an electrical connection to be made through the hinge, e.g. between different elements of the deployable structure, such that power and/or electrical signals may be provided to a component attached to an element of the deployable structure. It also enables feedback to be provided to confirm that the hinge has deployed correctly. Thus the electrical connection is only made, and thus power and/or electrical signals will only be provided, if the hinge has deployed correctly.

### BRIEF DESCRIPTION OF THE DRAWINGS

Embodiments of the invention will now be described, by way of example only, with reference to the accompanying drawings, in which:

FIGS. 1a, 1b and 1c show an embodiment of a hinge in accordance with the present invention;

FIGS. 2a and 2b show a further embodiment of a hinge in accordance with the present invention; and

FIGS. 3a, 3b, 3c and 3d show the embodiment of the hinge shown in FIGS. 2a and 2b during different stages of deployment.

### DETAILED DESCRIPTION

The embodiments of the hinge shown in the drawings are intended to be used to connect the elements in deployable structures such as antennas, solar panels, solar sails, etc., such that these interlinked elements are able to move in a coordinated fashion in order to deploy the structure. Such deployable structures, e.g. for launching into space are typically folded when launched and subsequently deployed when they reach their intended destination, e.g. orbit.

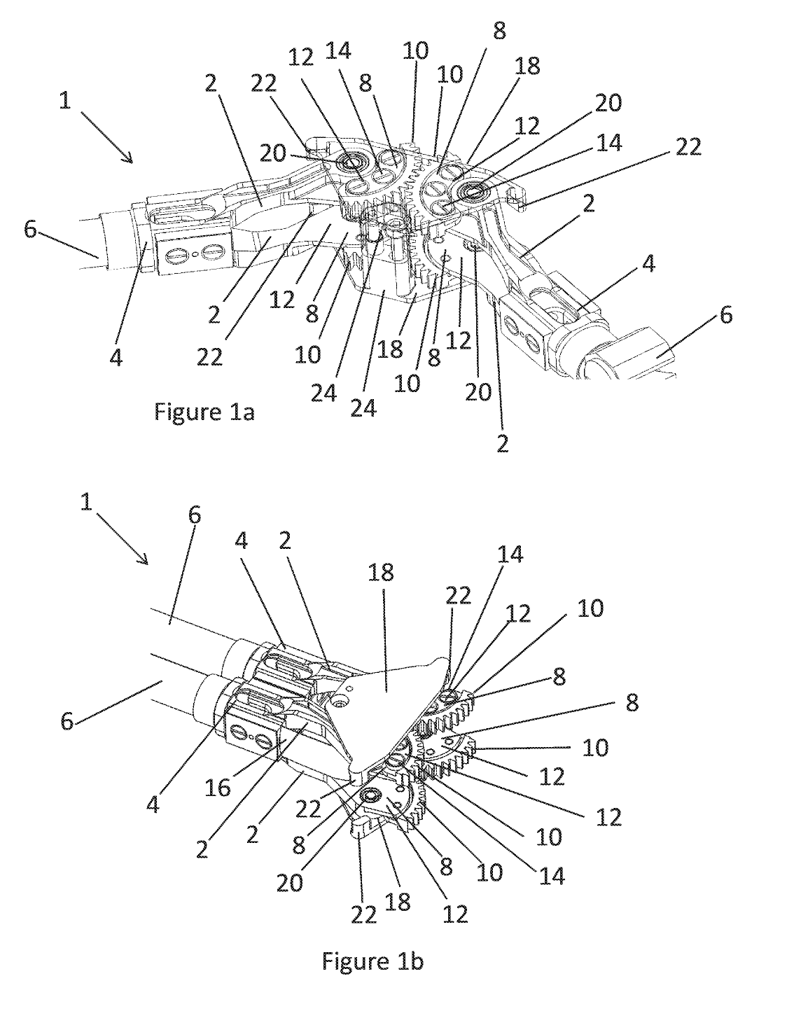

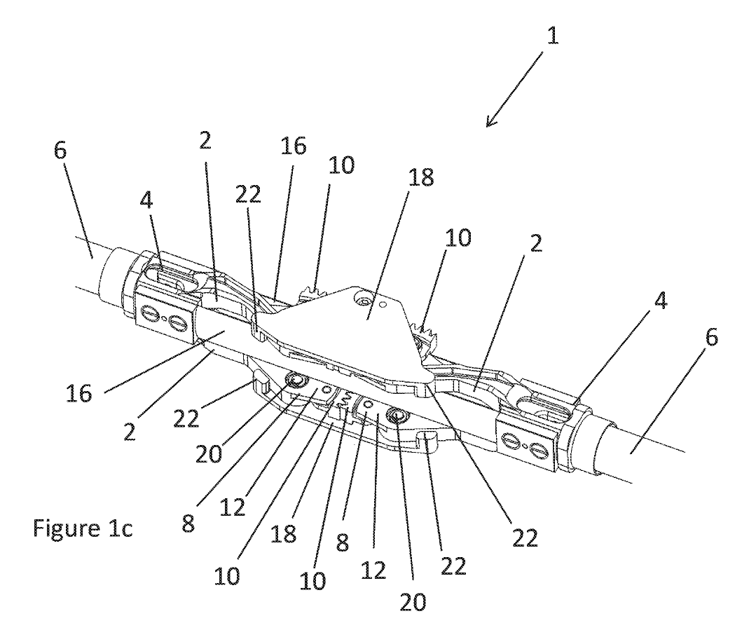

FIGS. 1a, 1b and 1c show a first embodiment of a hinge 1 in accordance with the present invention. The hinge 1 comprises two sets of two support members 2 (formed as struts) that each attach to respective elements 4 of a deployable structure (not shown) via a common mounting member 6, the hinge 1 being provided to allow rotation of the elements 4 relative to each other. At their other end, each of the support members 2 attaches to a respective gear 8.

The hinge thus comprises two sets of two spur gears 8, with each pair of gears comprising a gear support 12 and meshing together at the gear teeth 10. The gear teeth 10, which form an arc of 110 degrees around the circumference of each gear 8, are made of PEEK and attached to the respective gear support 12 with three screws 14. Using PEEK for the gear teeth 10 provides increased friction between the gear teeth 10 that helps to minimise any slipping between the gears 8 during deployment. The gear supports 12 are integrally moulded with the respective support member struts 2 from aluminium.

Each set of gear teeth 10 (and thus each gear 8) has the same radius of curvature and thus each set of two meshing gears has a gear ratio of 1.

Attached to, and extending between, each common mounting member 6 of the support are two tape springs 16 (not shown in FIG. 1a for the purposes of clarity). The tape springs 16 are made from Beryllium Copper and are attached parallel to each other on opposite sides of the mounting members 6. The tape springs 16 are attached to the mounting members 6 such that they each lie substantially in a plane perpendicular to the planes in which the gears 8 are arranged to rotate. The tape springs 16 each have a curved cross section (at least in their longitudinally extended configuration as shown in FIG. 1c) and are attached to the mounting members 6 such that their concave sides are facing each other.

The hinge 1 also comprises two retaining plates 18 (shown in outline only in FIG. 1a for the purposes of clarity) that are attached to either side of the hinge 1 and lie in planes parallel to the planes in which the gears 8 rotate. Integrally formed in each of the retaining plates 18 are two axles 20 for the respective pair of gears 8. The axles 20 extend in a direction perpendicular to the retaining plates 18 at the point at which the respective support member struts 2 attaches to the respective gear supports 12 and forms the axis about which each gear 8 rotates. The axles 20 thus form a plain bearing with the gear supports 12 and allow each pair of gears 8 to rotate relative to each other and the respective retaining plate 18, with the retaining plate 18 acting to maintain a constant distance between the axles 20 and thus the axes of rotation of the gears 8.

The attachment of the retaining plates 18 to the respective pair of gears 8 by means of the axles 20 integrally formed in the retaining plates 18 acts to constrain the rotation of the gears 8 to a plane perpendicular to their axles 20, and thus restrict the movement of the gears 8 in directions out of this plane.

Also integrally formed in each of the retaining plates 18 are a pair of stops 22 that project from the edge of the retaining plates 18, perpendicularly to the plane of the retaining plates 18 and are arranged to engage with the support members 2 when the hinge 1 is in is fully extended configuration, i.e. in the configuration shown in FIG. 1c. The stops 22 thus prevent the hinge 1 from opening out to an angle greater than that shown in FIG. 1c, thus preventing the tape springs 16 from overshooting their fully extended configuration.

Integrally formed with each of the two retaining plates 18 is a bracing member 24 that helps to keep the retaining plates 18 fixed in the same respective planes and thus helps to restrict the movement of the gears 8 in directions out of their planes of rotation. When the hinge is in its fully folded configuration (as shown in FIG. 1b) the bracing member 24 also acts as a stop to help prevent the hinge 1 from being folded beyond this position.

In operation, the hinge 1 is connected between, and thus interlinks, two elements 6 of a deployable structure. Before deployment, e.g. for launch on a spacecraft, the hinge 1 is folded into the folded configuration shown in FIG. 1b. In this configuration the tape springs 16, which are held at their respective two ends by the common mounting members 4, are bent along a direction parallel to the axes of the gears 8. When the tape springs 16 are bent like this, they possess an amount of stored strain energy. To counter this, and thus to retain the hinge 1 in its folded configuration during launch of the spacecraft, for example, before it is desired to be deployed, the hinge comprises a release mechanism (not shown as it is attached to the elements 4 of the deployable structure) for holding the hinge 1 (and thus the tape springs 16) in its folded configuration.

In the folded configuration (as shown in FIG. 1b) the bracing member 24 acts as a stop, engaging with the edges of the support members 2 to prevent the hinge 1 from being folded back further than the configuration shown in FIG. 1b, e.g. under the action of the release mechanism.

When the deployable structure (and therefore the hinge 1) is desired to be deployed, e.g. when the spacecraft reaches its destination, the release mechanism releases the hinge 1 such that stored strain energy of the tape springs 16 can be used to actuate the hinge 1 through the partly unfurled configuration shown in FIG. 1a and towards its fully extended configuration as shown in FIG. 1c.

This unfurling of the tape springs 16 acts to rotate the gears 8 of the hinge 1, via their connection to the support members 2 to which the tape springs 16 are attached, and thus actuates the hinge 1 from its folded configuration shown in FIG. 1b into its extended configuration shown in FIG. 1c. In this way, the actuation of the hinge 1 rotates the interlinked elements 6 of the deployable structure relative to each other to help deploy the deployable structure.

During the unfurling of the tape springs 16, the friction between the gear teeth 10 helps to control the deployment of the hinge 1, i.e. preventing it from unfolding too quickly. Also during unfurling, the retaining plates 18 (as well as the meshing gear teeth 10 to a lesser extent) act to constrain the rotation of the gears 8 within respective parallel planes and to restrict any movement of the gears 8 in directions out of these planes, which otherwise may be caused by the unpredictable movement (some of which may be out of plane) of the tape springs 16 during deployment.

This increased stiffness of the hinge 1 during deployment, owing to the action of the retaining plates 18, increases the accuracy and predictability of the hinge's 1 actuation by the tape spring 16 into its extended configuration.

When the tape springs 16 reach their fully extended configuration and the hinge 1 is opened fully, as shown in FIG. 1c, the stops 22 on the retaining plates 18 come into contact with the support member struts 2 to prevent the hinge 1 from opening beyond this position.

Once the tape springs 16 have unfurled fully and the hinge 1 has been opened fully into the extended configuration shown in FIG. 1c, the tape springs 16 lock along their length owing to the curvature of the tape springs 16 (in a direction perpendicular to the direction of longitudinal extension), thus holding the hinge 1 in its extended configuration shown in FIG. 1c. This locking of the tape springs 16, in addition to the action of the retaining plates 16, also increases the out of plane stiffness of the hinge 1 once it has been deployed, which thus increases the stiffness of the deployable structure of which it is a part.

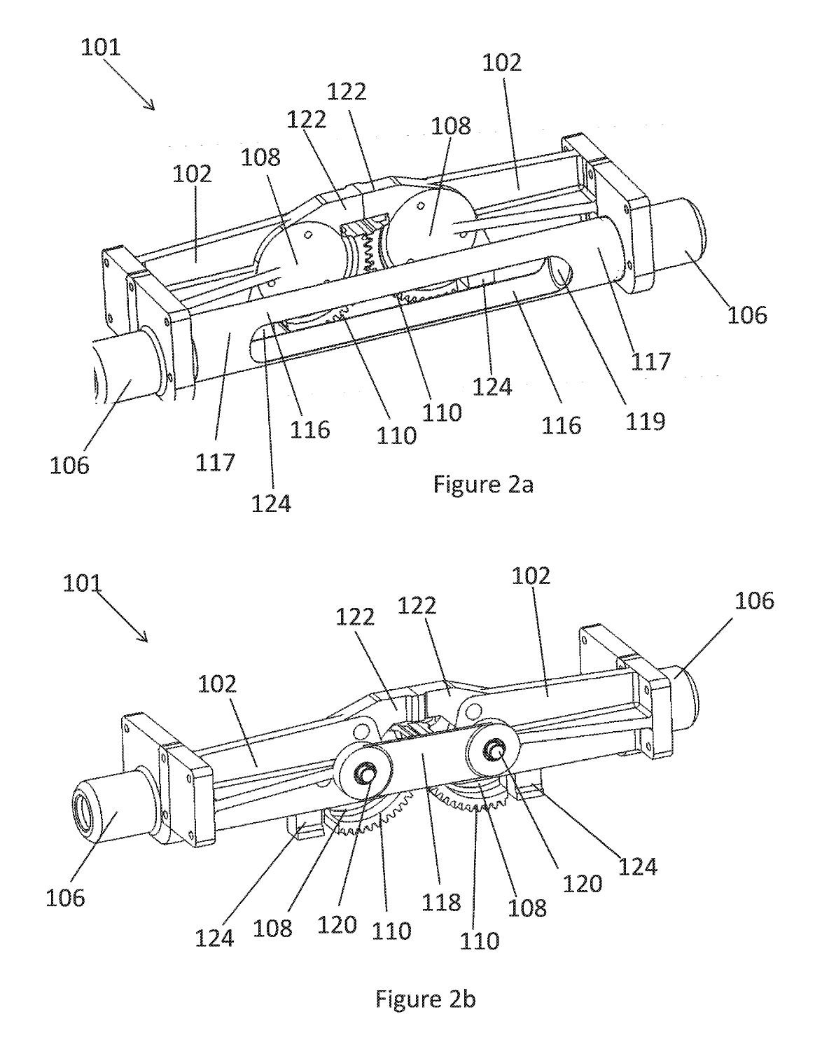

A further embodiment of the invention will now be described with reference to FIGS. 2a and 2b.

FIGS. 2a and 2b show the front and reverse views of a second embodiment of a hinge 101 in accordance with the present invention. The overall design of this embodiment of the hinge 101 is similar to embodiment of the hinge shown in FIGS. 1a, 1b and 1c, in that it also comprises two mounting members 106 onto which respective elements of a deployable structure (not shown) are able to attach, and two tape springs 116 that attach to and extend between the opposite sides of the mounting members 106 from where the deployable structure elements attach.

However the embodiment of the hinge 101 shown in FIGS. 2a and 2b differs from the embodiment shown in FIGS. 1a, 1b and 1c in that the hinge 101 comprises only a single pair of spur gears 108 (having equal radius of curvature and therefore a gear ratio of 1) that are attached by respective support members 102, which are offset from the tape springs 116, to the respective mounting members 106. Each gear 108, corresponding support member 102 and corresponding mounting member 106 is integrally formed as a single piece from a 3D printed thermoplastic.

The two integrally formed pieces engage at the two sets of gear teeth 110 and are held together by a retaining member 118 that mounts onto axles 120 that project from, and are integrally formed with, the gears 108. The axles 120 thus form a plain bearing with the retaining member 118 and allow each pair of gears 108 to rotate relative to each other and the retaining member 118, with the retaining member 118 acting to maintain a constant distance between the axles 120 and thus the axes of rotation of the gears 108.

The two tape springs 116 are integrally formed from a carbon fibre composite, with cylindrical portions 117 formed at each end of the tape springs 116 that are each mounted coaxially onto corresponding cylindrical portions 119 that project from the mounting members 106.

As with the embodiment shown in FIGS. 1a, 1b and 1c, the attachment of the retaining member 118 to the pair of gears 108 by means of the axles 120 integrally formed in the gears 108 acts to constrain the rotation of the gears 108 to a plane perpendicular to their axles 120, and thus restrict the movement of the gears 108 in directions out of this plane.

Also integrally formed in the pair of gears 108 is a pair of stops 122 that project from the edge of the gears 108, at a tangent to the edge of the gears 108 and are arranged to engage with each other when the hinge 101 is in is fully extended configuration, i.e. in the configuration shown in FIGS. 2a and 2b. The stops 122 thus prevent the hinge 101 from opening out to an angle greater than that shown in FIG. 1c, thus preventing the tape springs 116 from overshooting their fully extended configuration.

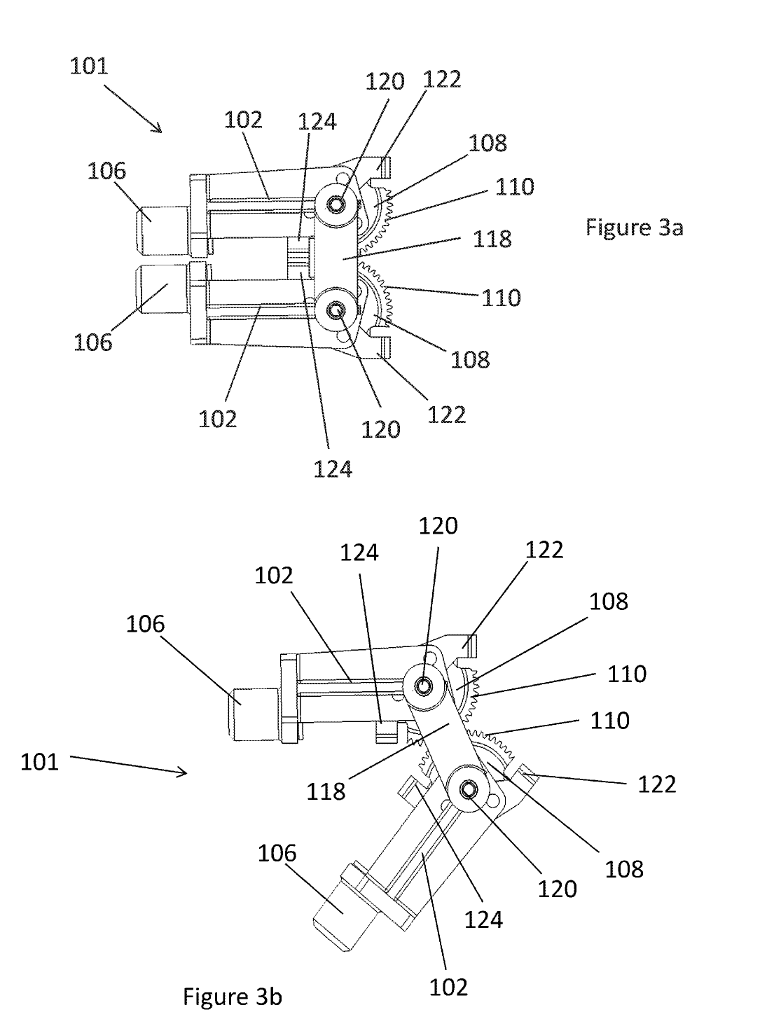

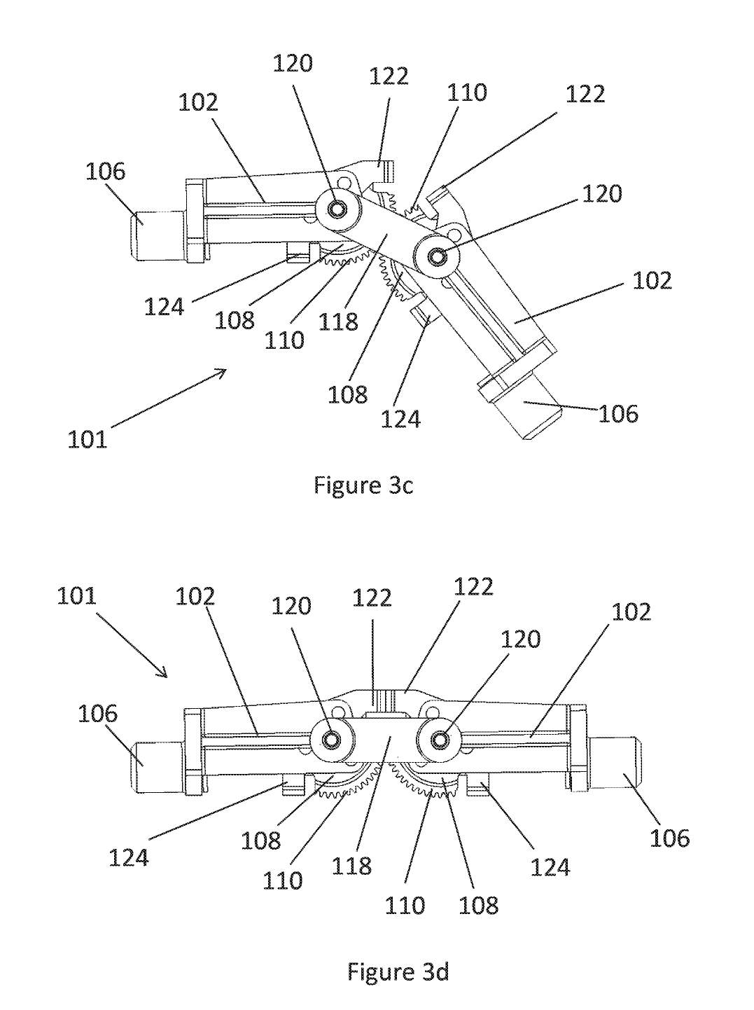

A second pair of stops 124 are also integrally formed in the pair of gears 108 that project from the other side of the gears 108. These stops 124 are arranged to prevent the hinge 101 from being folded back further than the configuration shown in FIG. 3a, e.g. under the action of a release mechanism (not shown).

Operation of the hinge 101 shown in FIGS. 2a, 2b and 2c will now be described with additional reference to FIGS. 3a, 3b, 3c and 3d that show the hinge 101 in different stages of deployment.

The operation of this embodiment of the hinge 101 is very similar to that of the embodiment shown in FIGS. 1a, 1b and 1c. The hinge 101 is connected between two elements of a deployable structure. Before deployment, the hinge 101 is held by a release mechanism in the folded configuration shown in FIG. 3a. The stops 124 engage together to prevent the hinge 101 from being folded back any further.

Upon deployment, the stored strain energy of the tape springs 116 actuates the hinge 101 through the partly unfurled configurations shown in FIG. 3b and then FIG. 3c until it reaches its fully extended configuration as shown in FIG. 3d. This unfurling of the tape springs 116 and the rotation of the hinge 101 thus acts to rotate the interlinked elements of the deployable structure (not shown, but which would be attached to the mounting members 106 of the hinge 101) relative to each other to help deploy the deployable structure.

When the tape springs 116 reach their fully extended configuration and the hinge 101 is opened fully, as shown in FIG. 3d, the stops 122 on the other side of the gears 108 come into contact to prevent the hinge 101 from opening beyond this position. As with the hinge 1 shown in FIGS. 1a, 1b and 1c, the tape springs 116 lock along their length when they have unfurled fully and the hinge 101 has been opened fully into the extended configuration shown in FIG. 3d, thus holding the hinge 101 in this configuration.

Again, as with the hinge 1 shown in FIGS. 1a, 1b and 1c, the retaining member 118 and the meshing of the gear teeth 110 in the hinge 101 shown in FIGS. 2a, 2b, 2c, 3a, 3b, 3c and 3d, as well as the locking of the tape springs 116, increases the out of plane stiffness of the hinge 101 during deployment and once it has been deployed, which thus increases the stiffness of the deployable structure of which it is a part.

It can be seen from the above that in at least preferred embodiments of the invention, a hinge for use in a deployable structure is provided that, owing to the provision of gears and a retaining member or plate, has an increased stiffness compared to conventional hinges, while also incorporating a tape spring as a low mass, reliable and simple actuation mechanism. This provides a particularly accurate and reliable hinge for use in deployable structures, e.g. for use in space.

1-17. (canceled)

18. A hinge for attachment between two elements in a deployable structure, the hinge comprising:
two support members each for attaching to or forming part of an element of the two elements of the deployable structure;
two gears in mesh with each other, each gear being attached to a respective one of the two support members, having a rotational axis, and being configured for rotation about its respective rotational axis, with the rotational axis of each gear being parallel to one another;
at least one tape spring attached to and extending between the support members, the at least one tape spring when extended longitudinally in a direction perpendicular to the rotational axes of the gears lying substantially in a plane parallel to the rotational axis of each gear, and the at least one tape spring being configured to actuate the hinge from a folded configuration in which the at least one tape spring is bent along a direction parallel to the rotational axis of each gear toward an extended configuration in which the at least one tape spring is extended longitudinally; and
a retaining member attached to one or both of the gears and the support members, the retaining member being arranged to restrict separation of the gears in a direction extending between the rotational axes of the gears.

19. The hinge as claimed in claim 18, wherein each gear has an axle, and the retaining member is attached to and extends between the axles of the gears.

20. The hinge as claimed in claim 18, wherein the retaining member is configured to restrict movement of the gears in directions outside a plane perpendicular to the rotational axis of each gear.

21. The hinge as claimed in claim 20, wherein the retaining member is configured to restrict movement of the gears in directions out of a plane perpendicular to the axes of the gears by less than 1 degree.

22. The hinge as claimed in claim 18, wherein each gear is attached to a respective one of the support members at a side of the gear opposed to teeth of the gear by which the gears are in mesh with each other.

23. The hinge as claimed in claim 18, wherein each support member is longitudinally extended, having one end for attaching to a respective element of the two elements of the deployable structure and an opposite end for attaching to a respective one of the gears.

24. The hinge as claimed in claim 18, wherein each gear includes teeth provided around an arc of a circumference of the gear, wherein the arc subtends an angle of between 80 and 140 degrees.

25. The hinge as claimed in claim 18, wherein the hinge is configured such that, in the extended configuration of the hinge, the at least one tape spring is allowed to extend into a fully longitudinally extended configuration such that the at least one tape spring is arranged to lock.

26. The hinge as claimed in claim 18, wherein the at least one tape spring comprises a plurality of tape springs.

27. The hinge as claimed in claim 26, wherein tape springs of the plurality of tape springs are arranged to be parallel to each other and spaced from each other in a direction perpendicular to planes in which the tape springs lie substantially.

28. The hinge as claimed in claim 18, further comprising a release mechanism for holding the hinge in the folded configuration and configured to release the hinge such that the at least one tape spring actuates the hinge towards its extended configuration.

29. The hinge as claimed in claim 18, further comprising an opening stop configured to prevent the hinge from opening greater than a predetermined opening angle.

30. The hinge as claimed in claim 29, wherein the opening stop is configured to allow the at least one tape spring to lock, but to prevent the hinge from opening substantially any further than the opening angle at which the tape spring locks.

31. The hinge as claimed in claim 18, further comprising a closing stop configured to prevent the hinge from being held together at less than a predetermined closing angle.

32. The hinge as claimed in claim 18, further comprising a bracing member that extends between two retaining members, the bracing member being configured to restrict movement of the two sets of gears relative to each other.

33. The hinge as claimed in claim 18, wherein one gear set is arranged on a first side of the tape spring, and another gear set is arranged on a second side of the tape spring.

34. A hinge for attachment between two elements in a deployable structure, the hinge comprising:
two sets of support members each for attaching to or forming part of an element of two elements of the deployable structure;
two sets of two gears in mesh with each other, each gear set being attached to a respective set of support members of the two sets of support members, each gear set having a rotational axis, and the gears in each gear set being configured for rotation about its respective rotational axis, with the rotational axis of each gear set being parallel to one other;
at least one tape spring attached to and extending between the support members, the at least one tape spring when extended longitudinally in a direction perpendicular to the rotational axes of the gear sets lying substantially in a plane parallel to the rotational axis of each gear, and the at least one tape spring being configured to actuate the hinge from a folding configuration in which the at least one tape spring is bent along a direction parallel to the rotational axis of each gear set toward an extended configuration in which the at least one tape spring is extended longitudinally; and
two retaining members, each retaining member being attached to one or both of the gear sets and/or the support members, each retaining member being arranged to restrict separation of gears of the respective gear sets in a direction extending between the rotational axes of the respective gears.
